(19) United States
(12) Patent Application Publication
(10) Pub. No.: US 2001/0035903 A1
(43) Pub. Date: Nov. 1, 2001

(54) Consumer video system for recording and playing video programming

(76) Inventor: David Trane, Longmont, CO (US)

Correspondence Address: Emery L. Tracy, P.O. Box 1518, Boulder, CO, 80306-1518, US

(21) Appl. No.: 09/817,849

(22) Filed: Mar. 26, 2001

Related U.S. Application Data
(60) Provisional application No. 60/192,642, filed on Mar. 27, 2000.

(51) Int. Cl. H04N 7/18; H04N 9/47

(52) U.S. Cl. 348/145

(57) ABSTRACT

A video recording system for recording and playing video programming is provided. The video recording system comprises a housing and at least one memory storage device for storing video programming mounted within the housing. An internet connection connects each memory storage device to the internet for downloading video programming through the internet connection and storing the downloaded video programming on the memory storage device. In addition, a device for removable recording video programming is provided. The device comprises a read/write removable media drive with read/write removable media receivable within the read/write removable media drive. An internet connection connects the read/write removable media drive to the internet for downloading video programming from the internet and storing the downloaded video programming on the read/write removable media. The stored video programming is then playable on a television.

The present application is a continuation of pending provisional patent application Serial No. 60/192,642, filed on Mar. 27, 2000, entitled “Digital Video Recorder and Digital Movie Player”.

### BACKGROUND OF THE INVENTION

1. Field of the Invention

This invention relates generally to a consumer video product and, more particularly, it relates to a digital replacement of the VCR in households for the purpose of recording and playing video programming that is brought into the home via airways, cable, satellite, or other media such as portable video recorders. Additionally, the present invention relates to the method, hardware, and software to download video from the internet.

2. Description of the Prior Art

Recently, a new product has emerged in the consumer electronic market-the “set top box”. The set top box hooks up to the television and allows a user to record and temporarily store television programming. The most significant feature of the set top box is that the set top box incorporates a temporary storage device, such as a hard disk drive, allowing for recording a television input or channel. Efforts are being made to incorporate the set top box directly into the television housing since the set top box specifically augments the television and does not necessarily replace any of the other audio and video entertainment systems including the current video tape VCRs commonly found in most households.

Another product for playing movies and the like currently on the market includes the DVD player. The DVD player is a pre-recorded movie player having a proprietary digital format. Still another product, which is no longer available to the consumer, is the DIVX player, which was designed solely as a movie player with an internet verification/authorization connection. To operate the DIVX player, a user would “rent” a movie by purchasing the CD movie at a designated retailer. Once the user initiated the movie in the DIVX player, the DIVX player would allow the movie to be repeatedly watched by the user for a predetermined time period. Once the predetermined time period had expired, the movie could not be played unless the user, through the DIVX player, contacted the service provider through the internet connection to “rent” additional time. Unfortunately, the DIVX system did not have permanent storage or read/write removable media. Furthermore, the DIVX system did not have any recording capability.

Therefore, a need exists for a complete consumer video system which plays media in digital format, i.e., DVD or other pre-recorded formats. In addition, there exists a need for a complete consumer video system which records analog or digital video into digital format and records it onto removable and non-removable media. Furthermore, a need exists for a complete consumer video system which accesses the internet as another source of video input that can be recorded or saved. Finally, there exists a need for a complete consumer video system which incorporates a temporary storage device allowing for recording one input or channel while watching another and allowing for time delay features that pause the output while continuing to download or record the input.

### SUMMARY

The present invention is a video recording system for recording and playing video programming. The video recording system comprises a housing and at least one memory storage device for storing video programming mounted within the housing. An internet connection that connects the memory storage devices to the internet. Downloading means downloads video programming through the internet connection and stores the downloaded video programming on the memory storage device. In addition, in an embodiment of the present invention, the video recording system has means for recording broadcast programming onto the memory storage device, the broadcast programming selected from the group consisting of television broadcasts, cable television input, and satellite input.

In addition, the present invention includes a device for recording video programming. The device comprises a read/write removable media drive with read/write removable media receivable within the read/write removable media drive. An internet connection connects the read/write removable media drive to the internet. Downloading means downloads video programming from the internet and stores the downloaded video programming on the read/write removable media.

Furthermore, the present invention includes a method for downloading video programming from any external internet location. The method comprises providing a storage device, connecting the storage device to the external internet location, encoding and decoding information from the external internet location, downloading the video programming, storing the video programming on the storage device, and playing the stored video programming on a television.

### BRIEF DESCRIPTION OF THE DRAWINGS

FIG. 1 is a perspective view illustrating a digital video recorder and movie player system, constructed in accordance with the present invention, having a memory storage device, a read/write removable media drive, an internet video connection, and connections for recording broadcast programming and downloading/playing it on a television set.

### DETAILED DESCRIPTION OF THE PREFERRED EMBODIMENTS

The present invention is a complete system that incorporates the ability to do the following:

a) play media in digital format, i.e., DVD or other pre-recorded media;

b) record analog or other non-digital video into digital format and record it onto removable media;

c) access the internet as another source of video input that can be recorded or saved; and

d) incorporate a temporary storage device allowing for recording one input or channel while watching another and allowing for time delay features that pause the output while continuing to download or record the input.

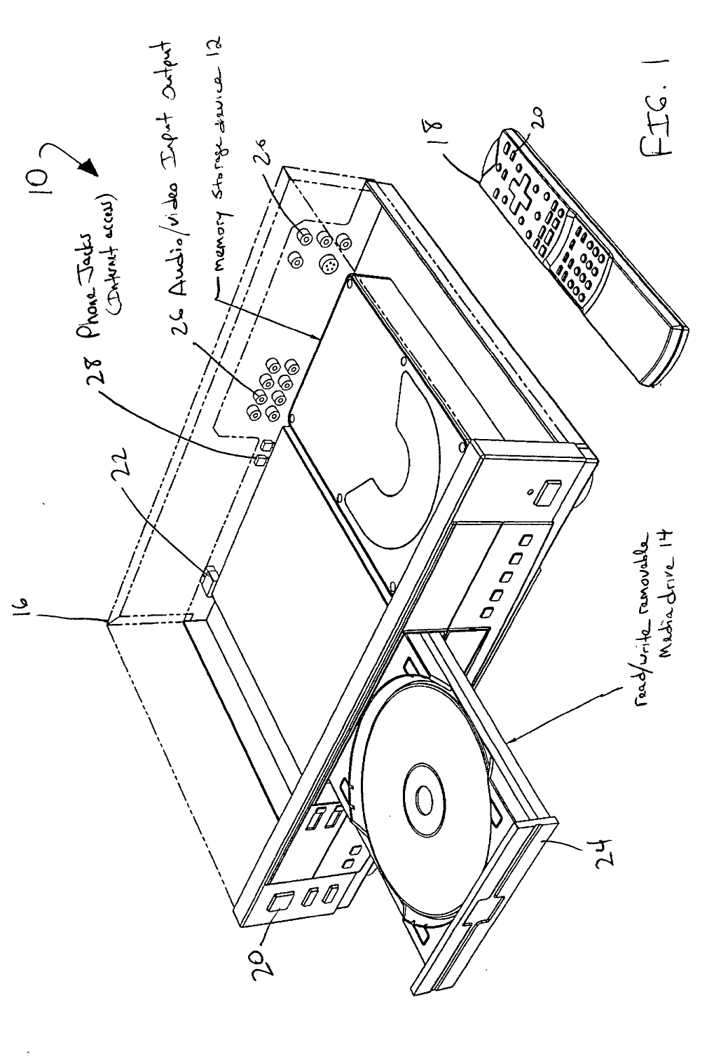

As illustrated in FIG. 1, the present invention is a consumer video system, indicated generally at 10, for recording and playing video programming downloaded through the internet or through broadcasts such as television, cable, satellite, or other broadcasts. The consumer video system 10 has at least one memory storage device 12, a read/write removable media drive 14, a system PCBA (not shown), internet access capabilities 28, mechanical housing 16, an external remote control device 18, and appropriate software and firmware (not shown). The consumer video system 10 of the present invention provides a user the full versatility of a conventional set-top box with the added benefits of downloading programs and information to read/write removable media and downloadable video capability from the internet. Furthermore, the consumer video system 10 allows the playing of pre-recorded video data.

The memory storage device 12 of the consumer video system 10 allows a user to download and store an analog or digital movie and/or television programming. Further, the memory storage device 12 includes a delayed play and watch feature which allows a user to stop or delay watching a movie or a television program and resume watching at a later time while the rest of the movie or television programming is still downloading into the memory storage device 12. It should be noted that the memory storage device 12 of the consumer video system 10 can be any type of memory storage device including, but not limited to, a hard disk drive, an optical drive, a memory chip device, et.

The read/write removable media drive 14 of the consumer video system 10 provides removability of any read/write removable media of a stored movie or television programming. The read/write removable media drive 14 can support any type of read/write removable media including, but not limited to, DVDs, CDs, mini-discs, floppy disks, etc. Additionally, the read/write removable media drive 14 provides the playing of prerecorded formats such as commonly found on DVD, mini-discs, floppy disks, and the like.

The system PCBA of the consumer video system 10 is typically mounted within the mechanical housing 16 and has the signal inputs, i.e., television broadcasts, cable, satellite, or internet, the electronics to convert the analog signal to digital format, and also the encoding and decoding function required to authorize downloading of movies or other programming from desired internet sites. The system PCBA of the consumer video system 10 additionally allows the recording of programming onto the memory storage device received from television broadcasts, cable television input, satellite input, and other broadcasts. The system PCBA further includes the appropriate software and hardware for playing the recorded video, either from the internet or broadcasts, on a television.

The system PCBA also contains all of the power supply and interface protocol and cabling to the memory storage device 12 and the read/write removable media drive 14. Furthermore, the system PCBA has necessary remote control functions to allow the remote control 18 to function.

The internet access 28 of the consumer video system 10 allows a user to download rented or paid for movies or other video from desired internet sites. A special button 20 can be provided on the mechanical housing 16 or on the remote control 18 to connect the user with any particular internet site to download movies. Such a feature allows the user the option of renting or buying a movie without ever leaving their home or business.

The mechanical housing 16 of the consumer video system 10 includes a power outlet 22 and a door 24 for the read/write removable media drive 14, internal power supply, user buttons (i.e., channel select, pause, arrows, power, play, record, etc.) and other desired aesthetic features to make the consumer video system 10 more desirable to the user. Additionally, the mechanical housing 16 includes all necessary and desired cable and data jacks 26 with access ports on the back panel, for connecting with cable boxes, stereos, televisions, internet, etc.

The external remote control device 18 of the consumer video system 10 is similar in size and shape to a typical television, VCR, and/or satellite remote control device. It should be noted that any size or type of remote control device 18, such as IR or RF, can be used.

The software and firmware of the consumer video system 10 contains sufficient software to allow the consumer video system 10 to function as described and desired. The software and firmware can be programmed to include features and benefits of the consumer video system 10 of the present invention such as programming by movie category, commercial skip, etc.

The programming, whether downloaded from any internet site or received from television broadcasts, cable television input, and satellite input, can be stored first on the memory storage device 12 or stored first on the removable media. Furthermore, the software and the firmware of the consumer video system 10 of the present invention allows the programming stored first on the memory storage device 12 to be recorded on the read/write removable media. Likewise, the software and the firmware allow the programming stored first on the read/write removable media to be recorded on the memory storage device 12.

The consumer video system 10, as discussed above, is able to completely replace the current VCR unit most people have in their homes with added functionality of doing so digitally. Ease of use and benefits to the user are numerous including the ability to download movies and other programming through an internet connection onto read/write removable or fixed media for playing of the downloaded movies and television programming at a remote site.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A video recording system for recording and playing video programming, the video recording system comprising:
a housing;
at least one memory storage device for storing video programming, each memory storage device being mounted within the housing;
an internet connection for connecting the memory storage device to the internet; and
downloading means for downloading video programming through the internet connection and storing the downloaded video programming on the memory storage device.

2. The video recording system of claim 1 and further comprising:
recording means for recording broadcast programming onto the memory storage device, the broadcast programming selected from the group consisting of television broadcasts, cable television input, and satellite input.

3. The video recording system of claim 1 and further comprising:
a button mounted to the housing for activating the internet connection and connecting to any predetermined internet site.

4. The video recording system of claim 1 wherein the downloading means comprises software and firmware for converting analog signals to digital format and encoding and decoding means for authorizing downloading from predetermined internet sites.

5. The device of claim 1 and further comprising:
a read/write removable media drive that is selected from the group consisting of a read/write CD drive, a read/write mini-disc drive, a floppy disc drive, and a read/write DVD drive, and further wherein the read/write removable media is selected from the group consisting of a read/write CD, a read/write mini-disc, a floppy disc, and a read/write DVD.

6. The device of claim 5 and further comprising:
means for recording from the memory storage device to the read/write removable media.

7. The video recording system of claim 1 and further comprising:
temporary storage means within the housing for allowing recording of at least one input or channel while playing another input or channel.

8. The video recording system of claim 1 and further comprising:
an external remote control device for controlling the operations of the video recording system.

9. The video recording system of claim 1 and further comprising:
a data jack for connecting the memory storage device and read/write removable drive to the internet.

10. A method of downloading video programming with a video recording system of claim 1.

11. A device for recording video programming, the device comprising:
a read/write removable media drive;
read/write removable media receivable within the read/write removable media drive;
an internet connection for connecting the read/write removable media drive to the internet; and
downloading means for downloading video programming from the internet and storing the downloaded video programming on the read/write removable media.

12. The device of claim 11 and further comprising:
means for recording broadcast programming of television broadcasts, cable television input, and satellite input onto the read/write removable media.

13. The device of claim 11 wherein the read/write removable media drive is selected from the group consisting of a read/write CD drive, a read/write mini-disc drive, a floppy disc drive, and a read/write DVD drive, and further wherein the read/write removable media is selected from the group consisting of a read/write CD, a read/write mini-disc, a floppy disc, and a read/write DVD

14. The device of claim 11 and further comprising:
at least one memory storage device for storing video programming downloadable through the internet; and
means for transferring video programming between read/write removable media within the read/write removable media drive and the memory storage device.

15. The device of claim 14 and further comprising:
recording means for recording broadcast programming onto the memory storage device, the broadcast programming selected from the group consisting of television broadcasts, cable television input, and satellite input.

16. The device of claim 14 and further comprising:
means for recording to the memory storage device first and then transferring the recorded programming to the read/write removable media.

17. The device of claim 14 and further comprising:
means for recording to the read/write removable media first and then transferring the recorded programming to the memory storage device.

18. The device of claim 11 and further comprising:
a data jack for connecting the memory storage device and read/write removable drive to the internet.

19. The device of claim 11 wherein the downloading means comprises software and firmware for converting analog signal to digital format and encoding and decoding means for authorizing downloading from predetermined internet sites and transferring between the memory storage device and the read/write removable drive.

20. The device of claim 11 and further comprising:
temporary storage means for recording of at least one input or channel while playing another input or channel.

21. A method for recording video programming with the device of claim 11.

22. A method for downloading video programming from any external internet location, the method comprising:
providing a data storage device;
connecting the storage device to the external internet location;
encoding and decoding information from the external internet location;
downloading the video programming;
storing the video programming on the data storage device; and
playing the stored video programming on a television.

23. The method of claim 22 and further comprising:
receiving television, cable, satellite, or other broadcasts; digitizing the broadcasts; and recording the broadcasts on the data storage device.

24. The method of claim 22 and further comprising:
transferring the downloaded video programming to a read/write removable media.

25. The method of claim 22 and further comprising:
transferring the downloaded video programming to a memory storage device.

26. The method of claim 22 and further comprising:
temporarily storing the downloaded video programming prior to the storing of the downloaded video programming on the storage device.
